(19) United States
(12) Patent Application Publication
(10) Pub. No.: US 2016/0336764 A1
(43) Pub. Date: Nov. 17, 2016

(54) METHOD FOR EQUALISING STATE OF CHARGE IN A BATTERY

(71) Applicant: ROBERT BOSCH GMBH, Stuttgart (DE)

(72) Inventors: Jens Becker, Ludwigshafen Am Rhein (DE); Andre Boehm, Marbach am Neckar (DE); Christian Korn, Stuttgart (DE)

(21) Appl. No.: 15/111,211

(22) PCT Filed: Dec. 22, 2014
(86) PCT No.: PCT/EP2014/079047

§ 371 Date: Jul. 13, 2016

(30) Foreign Application Priority Data
Jan. 15, 2014 (DE) 10 2014 200 619.8

(51) Int. Cl. H02J 7/00; H01M 10/48; H01M 10/44

(52) U.S. Cl. CPC H02J 7/0014; H01M 10/44; H01M 10/48; H02J 7/0068; H01M 2010/4271

(57) ABSTRACT

The invention relates to a method for equalising state of charge in a battery that has a plurality of battery units (2-1, 2-2). This involves provision for a state of charge value for at least one battery unit (2-1, 2-2) to be ascertained, a decision value concerning whether a prior state of charge value for the at least one battery unit (2-1, 2-2) can be updated to be ascertained, the prior state of charge value for the at least one battery unit (2-1, 2-2) to be updated in order to obtain a present state of charge value for the at least one battery unit (2-1, 2-2) if the decision value concerning whether the prior state of charge value for the at least one battery unit (2-1, 2-2) can be updated exceeds a threshold value, a state of charge equalisation requirement value to be ascertained on the basis of the present state of charge value and the at least one battery unit (2-1, 2-2) to be discharged on the basis of the ascertained state of charge equalisation requirement value. In addition, a computer program and a battery management system are specified which are designed for implementing the method, as well as a battery and a motor vehicle having a drive system which is connected to such a battery.

### BACKGROUND OF THE INVENTION

The invention relates to a method for equalizing state of charge in a battery comprising a plurality of battery units.

Also proposed are a computer program and a battery management system, which are designed for the execution of the method, together with a battery and a motor vehicle, the drive system of which is connected to a battery of this type.

In hybrid and electric vehicles, battery packs using nickel-metal hydride technology or lithium-ion technology are employed, comprising a large number of series-connected electrochemical cells. The battery is monitored by a battery management system which, in addition to a safety monitoring function, is intended to ensure the maximum possible service life of the battery.

One function of the battery management system is the mutual tuning of the states of charge (SOC) of the individual battery units, notwithstanding their different levels of spontaneous discharge and different charging efficiencies. This is achieved, for example, by the appropriate equalizing of the states of charge battery units (battery balancing), which is generally achieved by resistive means. A resistive charge equalization method of this type is described, for example, in DE 10 2009 002 466 A1. In this document, an inductive charge equalization method is also described as an alternative.

DE 10 2008 002 100 A1 discloses a method for equalizing state of charge in vehicle batteries, wherein the state of charge values of the cells are determined by voltage measurement, preferably during a resting phase. An appropriate time point, for example, is considered immediately after the “ignition on” action, or after the activation of a control device which is used to execute the measurement. In a further step, from the states of charge of the individual cells, a charge quantity is calculated by which each cell must be discharged until its state of charge corresponds to that of the weakest cell.

DE 10 2010 043 912 A1 discloses a method for the determination of the state of charge of cells in a battery, wherein an algorithm is alternately and sequentially executed for cell equalization and the determination of battery status. The alternating execution of the algorithm for cell equalization and the determination of battery status is terminated in response to a preset state of charge.

In addition to different rates of spontaneous discharge, the capacities of battery cells also show mutual deviations associated with the diversification of product lines. Although, at the start of service life, this effect is negligibly small, it may be exacerbated as the service life proceeds by differences in cell ageing, thereby resulting in capacity differences of several percent.

### SUMMARY OF THE INVENTION

In a method according to the invention for equalizing state of charge in a battery that has a plurality of battery units, it is provided that:

a) a state of charge value is ascertained for at least one battery unit,

b) a decision value as to whether a prior state of charge value of the at least one battery unit can be updated is ascertained, wherein the decision value is at least dependent upon a prior stage of charge value of the at least one battery unit, and upon the state of charge value ascertained for the at least one battery unit,

c) the prior state of charge value of the at least one battery unit is updated in order to obtain a present state of charge value of the at least one battery unit, if the decision value as to whether the prior state of charge value of the at least one battery unit can be updated exceeds a threshold value,

d) a state of charge equalization requirement value is ascertained on the basis of the present state of charge value and,

e) the at least one battery unit is discharged on the basis of the state of charge equalization requirement value ascertained,

whereby the decision value exceeds the threshold value, if the state of charge value ascertained is greater than a specific percentage of the prior state of charge value.

The decision value is dependent upon the ratio of the state of charge value ascertained to the prior state of charge value. Accordingly, the state of charge value is updated conditionally, rather than periodically. Conversely, state of charge equalization can be executed periodically throughout. Alternatively or additionally, state of charge equalization may be triggered by events, such as a “charging complete” state. A plurality of methods will be familiar to a person skilled in the art. State of charge equalization will be executed on the basis of the prior state of charge values, where a measurement has been completed but no updating has been applied, and will be executed on the basis of the state of charge values ascertained, where updating has been applied.

A further advantage is that the method proceeds independently of the driver profile, i.e. independently of the performance profile associated with the use of the battery.

It is particularly advantageous that the specific percentage of the prior state of charge value should be a fixed number equal to or greater than 100%. A percentage between 100% and 200% is preferred.

Accordingly, the most recently measured state of charge values will only be overridden if the new state of charge value is higher than the most recently measured value. Thus, for state of charge equalization, the highest state of charge value since the most recent state of charge equalization is always applied. By this method, state of charge equalization is not undertaken in response to any random state of charge values of the battery unit, but only where state of charge values show a rising trend. Thus, by the measures proposed in the invention, no unnecessary charge equalization is undertaken. This has a specific advantage, in that the unnecessary heat-up and the more rapid ageing of the components in the state of charge equalization electronic circuit is prevented. During state of charge equalization, the rise in temperature may typically be of the order of 40 K. Moreover, the rapid ageing of soldered connections, associated with the change of temperature caused by state of charge equalization, is prevented.

It is therefore particularly advantageous that the method is used in systems in which the capacity of the individual battery units is not known, and state of charge equalization proceeds by way of resistive battery state of charge equalization.

In a preferred embodiment, the decision value is dependent upon a prior state of charge value of the at least one battery unit, upon the state of charge value ascertained for the at least one battery unit, and additionally upon the time of determination of the state of charge value ascertained.

According to a preferred embodiment, the state of charge value is ascertained in step a), following a resting phase of the battery. The dependence of the decision value upon the time of determination is preferably configured as a dependence upon the duration of the resting phase. It can thus be achieved that, in the event of a short resting phase, an older and more accurate measurement is not overridden by a less accurate measurement, if the change in the state of charge value is barely significant. Moreover, the resting phase is preferably ended by the transition of the battery to an operative state, for example drive operation or charging operation, or by state of charge equalization.

According to a preferred embodiment, after discharging in step e), the current state of charge value of the battery units is reset. In order to reobtain a correct value for the state of charge value of the battery units, a new initial measurement of the state of charge value of the at least one battery unit can be executed immediately after state of charge equalization. It is particularly advantageous that, for each power cycle of the battery, a maximum state of charge value for the battery can be determined accordingly.

The calculation of the state of charge value (SOC) of the battery unit is generally based upon a model of the battery unit. For example, the state of charge value is determined on the basis of a charging current and an open-circuit voltage (OCV) in the battery.

According to the invention, a computer program is also proposed, by means of which one of the methods described herein is executed, where the computer program is run on a programmable computing device. The computer program may be specifically be a module for the implementation of a battery state of charge equalization system or a module for the implementation of a battery management system in a vehicle. The computer program can be stored on a machine-readable storage medium, such as a permanent or rewritable storage medium, or by the assignment thereof to a computing device, for example on a portable storage device, such as a CD-ROM, a DVD, a USB stick or a memory card. Additionally or alternatively, the computer program may be made available for downloading on a computing device, for example a server or a cloud server, for example via a data network, such as the Internet, or a communication link, such as a telephone line or a wireless connection.

According to a further aspect, a battery management system comprises a battery that has a plurality of battery units,

a unit for ascertaining the state of charge value of at least one battery unit,

a unit for ascertaining a decision value as to whether a prior state of charge value of the at least one battery unit can be updated, wherein the decision value is at least dependent upon a prior state of charge value of the at least one battery unit, and upon the state of charge value ascertained for the at least one battery unit,

a unit for the updating of the prior state of charge value of the at least one battery unit in order to obtain a present state of charge value for the at least one battery unit, if the decision value exceeds a threshold value,

a unit for ascertaining the state of charge equalization requirement value on the basis of the present state of charge value,

and a unit for the control of the discharging of the at least one battery unit, on the basis of the state of charge equalization requirement value ascertained,

whereby the decision value exceeds the threshold value, if the state of charge value ascertained is greater than a specific percentage of the prior state of charge value.

According to the invention, a battery, specifically a lithium-ion battery or a nickel-metal hydride battery is also proposed, which comprises a battery management system and is preferably connectable to a drive system of a motor vehicle, whereby the battery management system is configured as described above and/or is designed for the execution of the method according to the invention.

In the present description, the terms “battery” and “battery unit”, in accordance with conventional usage, are applied as equivalents for “accumulator” and “accumulator unit”. The battery preferably comprises one or more battery units, which may describe a battery cell, a battery module, a module string or a battery pack. The term battery pack describes a number of cells which are spatially combined and, in many cases, are provided with a housing or cladding. The battery cells are preferably permanently interconnected, and interconnected in circuit, for example in series or in parallel, to form battery modules. A number of battery modules may be combined in circuit to form “battery direct converters” (BDCs), and a number of battery direct converters may be combined in a “battery direct inverter” (BDI).

According to the invention, a motor vehicle with a battery of this type is also proposed, whereby the battery is connected to a drive system of the motor vehicle. The method is preferably applied to electrically-powered vehicles, wherein a plurality of battery cells are combined in circuit to deliver the requisite drive voltage for the vehicle.

### BRIEF DESCRIPTION OF THE DRAWINGS

Exemplary embodiments of the invention are represented in the drawings and described in greater detail in the following description. Herein:

FIG. 1 shows a schematic representation of two battery units of different capacities during the execution of a state of charge equalization method according to the prior art,

FIG. 2 shows a schematic representation of states of charge over time in two exemplary driving cycles, and

FIG. 3 shows a schematic representation of a battery management system.

### DETAILED DESCRIPTION

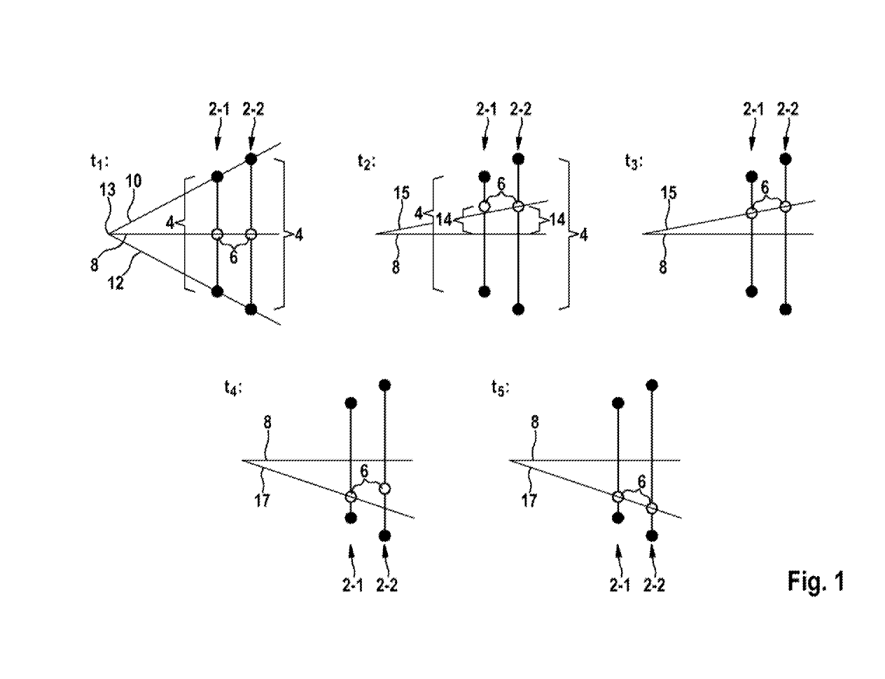

FIG. 1 shows two battery units 2-1, 2-2, with different capacities 4. The battery units 2-1, 2-2 are represented at five different time points t₁, t₂, . . . t₅, at which they generally show different states of charge 6. In order to represent the background to the process steps according to the invention, FIG. 1 shows a schematic representation of the battery units 2-1, 2-2 of different capacity 4 during the execution of a state of charge equalization method according to the prior art. The battery units 2-1, 2-2 are arranged along a plurality of model projection lines 8, 10, 12, 15, 17, which radiate outwards from a reference point 13. The battery units 2-1, 2-2 show various state of charge values 6.

At the first time point t₁, a first model projection line 8 runs through state of charge values 6 at 50% of the capacity 4, a second model projection line 10 runs through the state of charge value at 100% of the capacity 4, and a third model projection line 12 runs through the state of charge value 6 at 0% of the capacity 4.

At the first time point t₁, both battery units 2-1, 2-2 have a state of charge value 6 of 50%. Between the first time point t₁ and the second time point t₂, both battery units 2-1, 2-2 are charged by a charge amount 14. As the battery units 2-1, 2-2 have different capacities 4, they show a different state of charge value 6 at the second time point t₂. This is clarified by a fourth model projection line 15, which indicates identical states of charge 6 for the different battery units 2-1, 2-2.

Between the second time point t₂ and the third time point t₃, state of charge equalization is executed. To this end, the first battery unit undergoes a resistive partial discharge, until both state of charge values 6 of the battery units 2-1, 2-2 lie on the fourth model projection line 15, which indicates identical state of charge values 6 for the different battery units 2-1, 2-2.

Between the third time point t₃ and the fourth time point t₄, the battery is in operative service, which effectively corresponds to a discharge. Both battery units 2-1, 2-2 are discharged by an equal discharge amount (not represented). As the two battery units 2-1, 2-2 have different capacities 4, their relative state of charge value 6 is not equal, as shown by a fifth model projection line 17, which indicates identical state of charge values 6 for the different battery units 2-1, 2-2.

Between the fourth time point t₄ and the fifth time point t₅, a further state of charge equalization is executed. In this case, the second battery unit 2-2 is partially discharged, in order to achieve a uniform state of charge value 6, as represented by the fifth time point t₅.

From FIG. 1, it will be seen that the equalization requirement for the second state of charge equalization at time point t₅ has been partially fulfilled by the first state of charge equalization at time point t₃. In systems in which the capacity 4 of the individual battery units 2-1, 2-2 is not known, and resistive state of charge equalization is executed until a common state of charge value 6 is achieved, the overall equalization charge is very high, as unnecessary charging is executed via the state of charge equalization resistors, which far exceeds the strict equalization of the various spontaneous discharges. If the battery is permanently equalized by this method, so that all battery units 2-1, 2-2 have the same state of charge value 6, this does not just entail unnecessary charging via the balancing resistors. At the same time, there will be an unnecessarily high number of switching operations in the state of charge equalization unit, resulting in a significant reduction in the service life of electronics.

Conversely, according to the invention, the most recently measured state of charge values 6 will only be overridden if the new state of charge value 6 is higher than the most recently measured value. Accordingly, for state of charge equalization, the highest state of charge value 6 since the most recent state of charge equalization is always considered. Thus, state of charge equalization is not executed in response to random state of charge values 6 in the battery pack, but only where states of charge show a rising trend, thereby reducing the apparent requirement for state of charge equalization. After state of charge equalization, the previous measurement for the state of charge value will be invalid. In order to obtain a valid value, a new initial measurement is executed immediately after state of charge equalization.

In a preferred embodiment, the method therefore comprises the following steps:

1. Conditional state of charge measurement SOCᵢ and SOC_{MIN}=min(SOCᵢ)ᵢ for each battery unit

2. On the basis of SOC measurement, determination of the state of charge equalization requirement value.

Equalization charge for battery unit i:

Qᵢ=Cₙₒₘ*(SOCᵢ−SOC_{MIN}),

where Cₙₒₘ is the normal capacity of the battery units 2-1, 2-2.

3. Actuation of the state of charge equalization unit for a duration corresponding to the charge to be discharged Qᵢ.

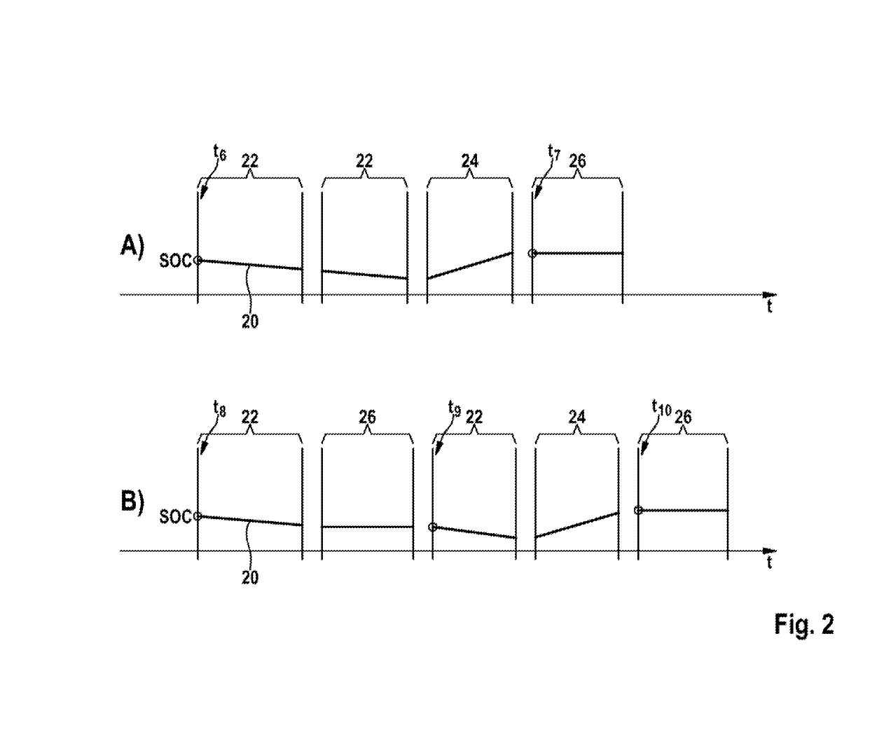

FIG. 2 shows exemplary characteristics 20 for a state of charge SOC of a battery in service. In the first example A), two operative service phases 22 of the battery are initially envisaged, during which the state of charge of the battery falls. The operative service phases are succeeded by a charging phase 24, and thereafter by a state of charge equalization phase 26. In the second example B), a sequence proceeds of a first operative service phase 22, a state of charge equalization phase 26, a second operative service phase 22, a charging phase 24 and a second state of charge equalization phase 26.

In the method proposed, it is envisaged that the state of charge value 6 is ascertained before the end of a resting phase. The resting phase is characterized in that, other than spontaneous discharge currents, no current flows in the battery units 2-1, 2-2. Accordingly, charging phases and running phases are classified, not as resting phases, but as service phases of the battery. The fact that the longer the battery unit is at rest, the lower the accuracy of state of charge measurement will be, is advantageously exploited.

Time points t₆ to t₁₀ represent exemplary time points, at which the state of charge values 6 of the battery units 2-1, 2-2 are ascertained. A sixth time point t₆ represents the start of the first operative service phase 22. A seventh time point t₇ represents the start of the state of charge equalization phase 26. Simultaneously, the seventh time point t₇ marks the end of the charging phase 24. At an eighth time point t₈, the first operative service phase 22 begins. At a ninth time point t₉, the second operative service phase 22 begins and the first state of charge equalization phase 26 ends. At a tenth time point t₁₀, the second state of charge equalization phase 26 begins and the charging phase 24 ends.

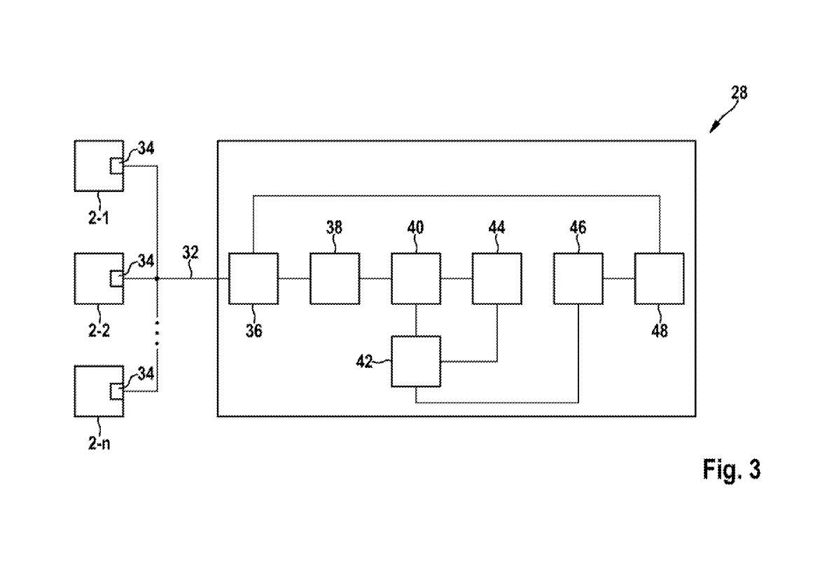

FIG. 3 shows an exemplary representation of the battery management system 28 according to the invention, which is designed for the monitoring and control of a number of battery units 2-1, 2-2, . . . 2-n. Communication between the battery units 2-1, 2-2, . . . 2-n and the battery management system 28 is effected by means of appropriate communication units 34, 36, which form interfaces to its communication channel 32, for example to a CAN bus. Alternatively, the battery management system 28 can be provided with a direct measuring line connection to the battery units 2-1, 2-2, . . . 2-n, such that communication via a bus is not required.

The battery management system 28 is provided with a unit 38 for ascertaining the state of charge value 6 of at least one battery unit 2-1, 2-2, . . . 2-n. The unit 38 for ascertaining the state of charge value 6 ascertains the state of charge value 6 of the battery units 2-1, 2-2, . . . 2-n, for example periodically, or in response to a command issued to this effect.

The battery management system 28 is provided with a unit 40 for ascertaining a decision value. The unit 40 for ascertaining the decision value receives data from the unit 38 for ascertaining the state of charge value 6 of the battery units 2-1, 2-2, . . . 2-n, and data from a unit 42 for ascertaining the current state of charge value 6 of the battery units 2-1, 2-2, . . . 2-n. By the comparison of the state of charge value 6 ascertained with the current state of charge value 6, and in consideration of the time points of ascertainment t₆, . . . t₁₀, or the difference between the time points of ascertainment t₆, . . . , t₁₀ for the prior state of charge value 6 and for the state of charge value 6 ascertained, the unit 40 calculates whether the current state of charge value 6 can be updated. If this is the case, the unit 40 for ascertaining a decision value actuates a unit 44 for the updating of the prior state of charge value 6, which updates the prior state of charge value 6.

The battery management system 28 is provided with a further unit 46 for ascertaining a state of charge equalization requirement value which, with reference to the current state of charge value 6, ascertains state of charge equalization requirement values for the individual battery units 2-1, 2-2, . . . 2-n. If the unit 46 for ascertaining the state of charge equalization requirement value receives a state of charge equalization command, it ascertains the state of charge equalization requirement value by issuing a query to the unit 42 for ascertaining the current state of charge value 6.

In the present example, the unit 46 for ascertaining state of charge equalization requirement values is also coupled to the unit 44 for the updating of the prior state of charge value 6, in order to allow the consideration, for example, of time points for the updating of the state of charge value 6.

The battery management system 28 is also provided with a unit 48 for controlling the discharge of the battery units 2-1, 2-2, . . . , 2-n on the basis of the state of charge equalization requirement values ascertained. The unit 48 for controlling the discharge of the battery units 2-1, 2-2, . . . 2-n receives data from the unit 46 for ascertaining the state of charge equalization requirement value. The unit 48 for the control of discharge is connected to the communication unit 36, which communicates with the battery units 2-1, 2-2, . . . 2-n.

The invention is not restricted to the exemplary embodiments described here, or to the aspects highlighted therein. Within the scope of disclosure of the claims, a plurality of variations are possible, which are consistent with the practice of a person skilled in the art.

1. A method for equalizing state of charge in a battery that has a plurality of battery units (2-1, 2-2, . . . 2-n), the method comprising:
a) ascertaining a current state of charge value (6) for at least one battery unit (2-1, 2-2, . . . 2-n),
b) ascertaining a decision value as to whether a prior state of charge value (6) of the at least one battery unit (2-1, 2-2, . . . 2-n) can be updated, wherein the decision value is at least dependent upon a prior stage of charge value (6) of the at least one battery unit (2-1, 2-2, . . . 2-n), and upon the current state of charge value (6) ascertained for the at least one battery unit (2-1, 2-2, . . . 2-n),
c) updating the prior state of charge value (6) of the at least one battery unit (2-1, 2-2, . . . 2-n) to obtain a present state of charge value (6) of the at least one battery unit (2-1, 2-2, . . . 2-n), if the decision value as to whether the prior state of charge value (6) of the at least one battery unit (2-1, 2-2, . . . 2-n) can be updated exceeds a threshold value,
d) ascertaining a state of charge equalization requirement value is on the basis of the present state of charge value (6) and,
e) discharging the at least one battery unit (2-1, 2-2, . . . 2-n) on the basis of the state of charge equalization requirement value ascertained,
characterized in that the decision value exceeds the threshold value, if the state of charge value (6) ascertained is greater than a specific percentage of the prior state of charge value (6).

2. The method as claimed in claim 1, characterized in that the specific percentage of the prior state of charge value is a fixed number equal to or greater than 100%.

3. The method as claimed in claim 1, characterized in that the state of charge value (6) is ascertained in step a), following a resting phase of the battery.

4. The method as claimed in claim 3, characterized in that the decision value is dependent upon the duration of the resting phase.

5. The method as claimed in claim 1, characterized in that, after discharging in step e), the current state of charge value (6) of the battery units (2-1, 2-2, . . . 2-n) is reset.

6. A computer program for the execution of one of the methods as claimed in claim 1, where the computer program is run on a programmable computing device.

7. A battery management system (28) of a battery comprising a plurality of battery units (2-1, 2-2, . . . 2-n), having
a) a unit 38 for ascertaining a state of charge value (6) of at least one battery unit (2-1, 2-2, . . . 2-n),
b) a unit (40) for ascertaining a decision value as to whether a prior state of charge value (6) of the at least one battery unit (2-1, 2-2, . . . 2-n) can be updated, wherein the decision value is at least dependent upon a prior state of charge value (6) of the at least one battery unit (2-1, 2-2, . . . 2-n), and upon the state of charge value (6) ascertained for the at least one battery unit (2-1, 2-2, . . . 2-n),
c) a unit (44) for updating the prior state of charge value (6) of the at least one battery unit (2-1, 2-2, . . . 2-n) in order to obtain a present state of charge value (6) of the at least one battery unit (2-1, 2-2, . . . 2-n), if the decision value exceeds a threshold value,
d) a unit (46) for ascertaining a state of charge equalization requirement value on the basis of the present state of charge value (6) and,
e) a unit (48) for controlling the state of charge of the at least one battery unit (2-1, 2-2, . . . 2-n) on the basis of the state of charge equalization requirement value ascertained,
wherein the decision value exceeds the threshold value, if the state of charge value (6) ascertained is greater than a specific percentage of the prior state of charge value (6).

8. A battery comprising a plurality of battery units (2-1, 2-2, . . . 2-n) and a battery management system (28) as claimed in claim 7.

9. A motor vehicle with a battery as claimed in claim 8, wherein the battery is connected to a drive system of the motor vehicle.
